(19) United States
(12) Patent Application Publication
(10) Pub. No.: US 2022/0322097 A1
(43) Pub. Date: Oct. 6, 2022

(54) UTILIZING DIFFERENT WIFI PASSWORDS TO SECURE COMMUNICATION LINKS OF A WIFI NETWORK

(71) Applicant: Microchip Technology Incorporated, Chandler, AZ (US)

(72) Inventor: Vaibhav Madan, Ulttar Pradesh (IN)

(21) Appl. No.: 17/303,018

(22) Filed: May 18, 2021

Related U.S. Application Data
(63) Continuation-in-part of application No. 17/301,522, filed on Apr. 6, 2021.

(51) Int. Cl. H04W 12/55; H04W 76/11; H04W 12/0431; H04W 12/06

(52) U.S. Cl. CPC H04W 12/55; H04W 76/11; H04W 12/0431; H04W 12/068

(57) ABSTRACT

One or more examples relate to utilizing different WiFi passwords to secure communication links of a WiFi network defined by a single service set identifier (SSID). In one or more examples, a method performed at a WiFi router establishing differently secured communication links may include: receiving, from a first WiFi device, a request to connect to a WiFi network; receiving, from the first WiFi device, a first message associated with performing a protocol for establishing a secure communication link with the WiFi device, the message including data derived from a first WiFi password configured at the first WiFi device; and attempting to learn the first WiFi password configured at the first WiFi device utilizing the data and at least one of a plurality of preconfigured WiFi passwords.

### CROSS-REFERENCE TO RELATED APPLICATION

The present application is a continuation in part of U.S. patent application Ser. No. 17/301,522, filed Apr. 6, 2021, and titled “PROVISIONING HEADLESS WIFI DEVICES AND RELATED SYSTEMS, METHODS AN DEVICES”, the contents and disclosure of which is hereby incorporated herein in its entirety by this reference.

### FIELD

One or more examples relate, generally, to WiFi networks. One or more examples relate to utilizing different passwords to secure communication links of a WiFi network and WiFi routers configured for the same.

### BACKGROUND

There is an ever-expanding variety of devices that connect to an electronic network, such as to a wireless local area network (WLAN) at a residence. Such a network is typically managed by a router, a device that, among other things, routes traffic (data packets) and manages requests by devices to connect to the network. Devices typically connect to a router via wired or unwired connections such as cables and wireless frequencies. Access points are devices that provide wireless connectivity between devices and a router. An access point typically has a wired connection to a router (e.g., an internal connection if a router has a built-in access point, or an Ethernet cable for a stand-alone access point, without limitation) and equipment to communicate wirelessly with other devices. Access points and other devices may be configured to utilize a variety of wireless communication protocols, but it is common for access points in residential networks to utilize communication protocols that are complaint with one of the Institute of Electrical and Electronics Engineers (IEEE) 802.11 standards for implementing WLAN computer communication, also referred to as “WiFi networks,” which is short for “wireless fidelity networks.”

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting a WiFi network defined by a service set identifier (SSID) that includes communication links between WiFi devices and a WiFi router, some or a totality of such communication links secured utilizing different WiFi passwords, in accordance with one or more examples.

FIG. 2 is a diagram depicting a process for securing communication links with a WiFi router utilizing different WiFi passwords, in accordance with one or more examples.

FIG. 3 is a flow diagram depicting a process for utilizing different WiFi passwords to establish secure communications with two WiFi devices, in accordance with one or more examples.

FIG. 4A is a flow diagram depicting a process for establishing a secure communication link with a WiFi device when WiFi devices attempt to connect to a WiFi network utilizing different WiFi passwords, in accordance with one or more examples.

FIG. 4B is a flow diagram depicting a process for attempting to learn a WiFi password configured at a WiFi device attempting to establish a secure communication link with a WiFi router, in accordance with one or more examples.

FIG. 5 is a block diagram depicting a WiFi router, in accordance with one or more examples.

FIG. 6 illustrates a 4-way handshake, in accordance with one or more examples.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example, or this disclosure, to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are example only and should not be construed as the only way to implement the present disclosure unless specified otherwise herein. Additionally, block definitions and partitioning of logic between various blocks are examples of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented utilizing any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

In this description the term “coupled” and derivatives thereof may be utilized to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The terms “on” and “connected” may be utilized in this description interchangeably with the term “coupled,” and have the same meaning unless expressly indicated otherwise or the context would indicate otherwise to a person having ordinary skill in the art.

Any reference to an element herein utilizing a designation such as “first,” “second,” and so forth does not limit the quantity or order of those elements, unless such limitation is explicitly stated. Rather, these designations may be utilized herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As utilized herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

A router that has an internal access point or is coupled to a stand-alone access point is referred to herein as a “wireless router,” and the access point of a wireless router is referred to herein as a “wireless router access point.” A wireless router configured for WiFi connections is referred to herein as a “WiFi router,” and an access point of a WiFi router is referred to herein as a “WiFi router access point.” Notably, a disclosed WiFi router may have one or multiple (more than one) access points, that provide the same or different types of connectivity such as, 2.5-Ghz frequency band, 5-Ghz frequency band, secured, and unsecured, without limitation.

When a WiFi device desires to connect to a WIFI router access point, typically, it will probe the WiFi signals and WiFi channels in its vicinity for the IEEE 802.11 wireless local area network (WLAN) service set identifier (SSID) broadcast by the WiFi router access point that defines a WiFi network. When the WiFi device detects an SSID on a WiFi channel, it sends a connection request to the WiFi router utilizing the detected SSID and channel of the WiFi router access point to notify the WiFi router that the WiFi device intends to attempt to connect to the WiFi router. When the WiFi router notifies the WiFi device that the WiFi router is ready for the WiFi device to attempt to connect, the WiFi device sends the WiFi router a description of the WiFi device's communication capabilities. If the capabilities are acceptable to the WiFi router, the WiFi router assigns and sends the WiFi device an identifier and notifies the WiFi device that the capabilities are acceptable and that the WiFi device may continue the connection process. The WiFi Device and WiFi router then establish a secure communication link.

Multiple protocols are available, and in utilize as part of a connection process, for establishing a secure communication link, such as a key agreement protocol or a challenge-response protocol, without limitation. In a typical key agreement protocol a WiFi device and a WiFi router each contribute some information (e.g., a one-time utilize number, sometimes randomly generated, typically referred to as a “cryptographic nonce” or just “nonce,” without limitation) and then the parties perform a series of steps utilizing the contributions and a shared secret (e.g., a WiFi password, without limitation) to generate encryption/decryption keys. If the WiFi device has the same shared secret as the WiFi router and performs the same key agreement protocol as the WiFi router, then the keys generated by the WiFi router and the WiFi device should be “symmetric.” If the parties generate a set of symmetric keys, then the WiFi device should generate decryption keys that can be utilized to decrypt messages encrypted by the WiFi router utilizing the WiFi router's generated encryption keys; and generate encryption keys to encrypt messages that the WiFi router can decrypt utilizing the WiFi router's generated decryption keys.

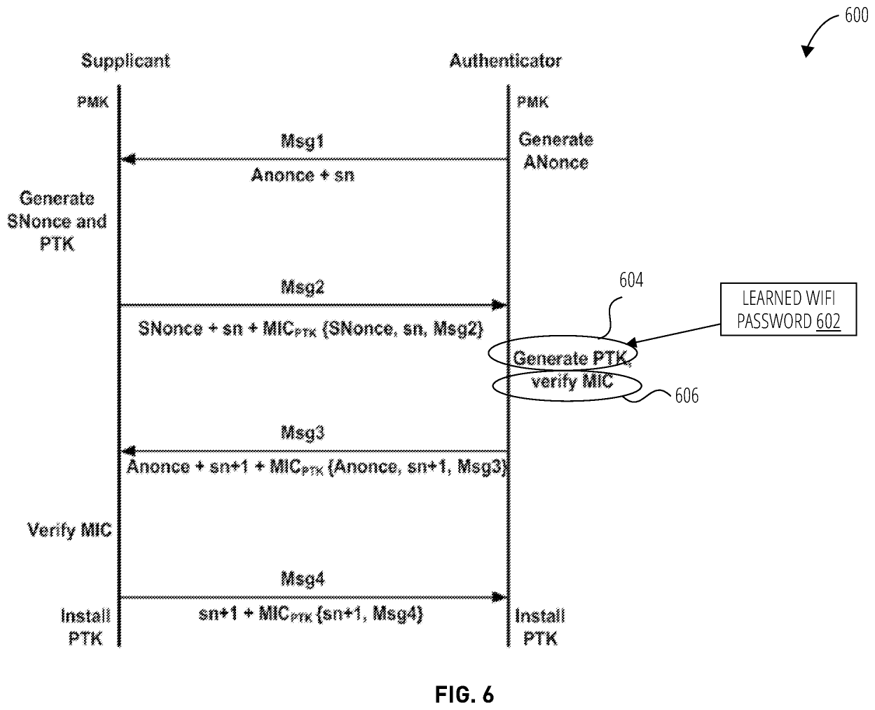

In the context of WiFi, an example key agreement protocol is the “4-way handshake,” so named because of four messages sent between the “authenticator” (e.g., the WiFi router) and the “supplicant” (e.g., the WiFi device). FIG. 6 is a diagram depicting an example 4-way handshake 600, in accordance with one or more examples. Four messages, Msg1, Msg2, Msg3, and Ms4 are sent between the Authenticator (e.g., a WiFi router, without limitation) and the Supplicant (e.g., a WiFi device attempting to connect to a WiFi router, without limitation).

Msg1 from the Authenticator to the Supplicant includes a first cryptographic nonce generated by the Authenticator, ANonce, and an optional sequence number, sn, both transmitted as plaintext. In the specific example of a 4-way handshake 600 depicted by FIG. 6 such sequence numbers are included in each of Msg1-Msg4 to identify the message sequence in the 4-way handshake 600 to which a byte of data pertains. For example, Msg1 and Msg2 are considered a first sequence, and Msg3 and Msg4 are considered a second sequence, and the optional sequence number is thus denoted sn+1.

The Supplicant generates a second cryptographic nonce, SNonce, a Message Integrity Code (MIC), and a Pair-Wise Transit Key (PTK). The PTK is a unique key that may be utilized to encrypt all unicast traffic between a WiFi device (the supplicant) and a WiFi router (the Authenticator). The Supplicant generates the PTK utilizing the ANonce, SNonce, and a Pair-Wise Master Key (PMK) derived from the WiFi password. The MIC is a hash of the PTK and contents of Msg2 (not including the MIC). MIC is generated by the Supplicant utilizing a hashing algorithm such as HMAC-SHA256 (Hash-Based Message Authentication Code Secure Hash Algorithm). Notably, since the PTK is derived from the PMK which is further derived from the WiFi password, the MIC is also derived, indirectly, from the WiFi password. Msg2 from the Supplicant to the Authenticator includes the SNonce, the sequence number sn and MIC.

The Authenticator generates the PTK utilizing the ANonce, SNonce, and PMK derived from the WiFi password (operation 604). If the Authenticator has the same ANonce, SNonce, and PMK and then it should generate the same PTK as the Supplicant. The Authenticator also generates a MIC (not depicted) that is, as a non-limiting example, at least in part, a hash of the PTK generated by the Authenticator and Msg2 utilizing the same hashing algorithm that the Supplicant utilized. The Authenticator verifies that the MIC sent in Msg2 matches the MIC that the Authenticator generated (operation 606). If the PTK generated by the Authenticator is the same as the PTK generated by the Supplicant, then the MIC generated by the Authenticator should be the same as the MIC received in Msg2. If the MIC is verified, the Authenticator sends Msg3 informing the Supplicant that the Authenticator verified the MIC and will install a PTK. Msg3 from the Authenticator to the Supplicant includes the ANonce, next sequence number sn+1, and MIC generated by the Authenticator by hashing the PTK and Msg3 (not including this new MIC). If not verified a failure message is sent.

The Supplicant generates another MIC by hashing the PTK generated by the Supplicant and Msg3, and verifies that the MIC in Msg3 matches the MIC generated by the Supplicant. If the MIC is verified, the Supplicant installs the PTK and sends the Authenticator Msg4 acknowledging that the Authenticator installed the PTK. Msg4 from the Supplicant to the Authenticator includes the next sequence number sn+1 and MIC generated by hashing the PTK and Msg4 (not including this new MIC).

A person having ordinary skill in the art would understand that a key agreement protocol such as the 4-way handshake 600 may include re-transmissions of messages and packets, sometimes numerous re-transmissions. While conditions for such re-transmissions are not discussed to avoid unnecessarily complicating the description and figures, such re-transmissions are specifically contemplated by, and do not exceed the scope of, the various examples and this disclosure.

As another non-limiting example, a WiFi router and a WiFi device may perform a challenge-response protocol (not depicted) to establish a secure a communication link. In a challenge-response protocol the WiFi router sends the WiFi device a message that includes a challenge text that the WiFi device is supposed to encrypt utilizing router credentials and send back to the WiFi router. The router credentials are generally a password. If the WiFi device and WiFi router have the same router credentials, then, when the WiFi router decrypts the encrypted response text, it should recover the challenge text. Recovering the challenge text authenticates the WiFi device and the WiFi device and WiFi router may establish a secure communication link.

If a WiFi router utilizes a challenge-response protocol, then any WiFi device that has the router credentials may utilize it to directly decrypt network traffic of other WiFi devices. If the WiFi router utilizes a key agreement protocol such as a the “4-way handshake,” then any WiFi device that has the WiFi password and the respective contributions of the parties to the handshake may generate the encryption and decryption keys utilized by those parties, and utilize the decryption keys to decryption network traffic of other WiFi devices. WiFi passwords and parties' respective contributions to a key agreement protocol may be acquired by, as non-limiting examples, reading from a WiFi device or capturing network traffic that includes such data. As a non-limiting example, a sniffer is a WiFi device or module of a WiFi device that is configured to monitor and record wireless network traffic. The records of “captured” wireless network traffic may be processed by the same or another device to observe data in the captured network traffic including the data exchanged during a 4-way handshake.

While respective contributions such as cryptographic nonces, without limitation, are one time utilize and sometimes randomly generated, WiFi passwords are typically the same for all WiFi devices that connect to a WiFi router. So, once a party has a WLAN's WiFi password then in cases such as where a challenge-response protocol is utilized all network traffic may be exposed, and in cases such as a key agreement protocol the party just has to acquire the respective contributions of the WiFi router and WiFi device attempting to connect in order to expose all network traffic.

As a matter of policy, some network administrators periodically change the WiFi password and provide the new WiFi password to known parties so that, at least initially, only those few known parties have the new WiFi password. However, once a party has a new WiFi password, they can decrypt the network traffic. Moreover, with the passage of time parties other than the known parties may acquire the new WiFi password, thereby again allowing undesired access to all network traffic.

Some WLANs employ a back-end WiFi infrastructure that adds secondary encryption to network traffic that is specific to each user or groups of users on the WLANs, such as the secure Lightweight Directory Access Protocol (LDAP), without limitation. The interoperability of such back-end WiFi infrastructures with a WLAN has to be maintained on an ongoing basis. Moreover, such back-end WiFi infrastructures are expensive to deploy and so beyond the means of most people setting up a residential WLAN.

The inventor of this disclosure appreciates that it would be desirable to utilize different WiFi passwords to secure communication links for WiFi devices connected to a WiFi network defined by a single SSID. Securing some or a totality of the communication links between WiFi devices and the WiFi router via different primary encryption (i.e., utilizing different WiFi passwords), would increase the complexity for a WiFi device attempting to listen to network traffic of other WiFi devices on a WiFi network.

One or more examples relate to utilizing different WiFi passwords to secure communication links between a WiFi router and WiFi devices attempting to connect to a WiFi network defined by a service set identifier (SSID), and a WiFi router configured to support the same. In one or more examples, a method performed at a WiFi router configured to support utilizing different WiFi passwords to secure communication links may include: receiving, from a first WiFi device, a request to connect to a WiFi network; receiving, from the first WiFi device, a first message associated with performing a protocol for establishing a secure communication link with the WiFi device, the message including data derived from a first WiFi password configured at the first WiFi device; and attempting to learn the first WiFi password configured at the first WiFi device utilizing the data and at least one of a plurality of preconfigured WiFi passwords.

One or more examples relate, generally, to establishing secure communication links between WiFi devices and a WiFi router utilizing different WiFi passwords. In one or more examples, a WiFi router is preconfigured with multiple WiFi passwords. A WiFi device that desires to connect to such a WiFi router is configured with one of the WiFi router's WiFi passwords. In a contemplated operation, a WiFi router is not aware, at least initially, of the specific WiFi password with which the WiFi Device was configured. When the WiFi device and a disclosed WiFi router perform a protocol to establish a secure communication link (e.g., a 4-way handshake type key agreement protocol as depicted by FIG. 6, without limitation), the WiFi device sends a message to the WiFi router that includes data derived from the WiFi password with which the WiFi Device was configured. A disclosed WiFi router will process the data, as a non-limiting example, prior to or during, operations 604 and 606 of 4-way handshake 600, in accordance with the protocol utilizing each of the preconfigured WiFi passwords until it either: (i) successfully processes the data utilizing one of the WiFi passwords, or (ii) fails to process the data utilizing any of the preconfigured WiFi passwords. The WiFi router learns the WiFi password (learned WiFi password 602) configured at the WiFi device upon successfully processing the data utilizing one of the preconfigured WiFi passwords. In one or more examples, successfully learning the WiFi password configured at the WiFi device may serve to verify the data sent by the WiFi device. In one or more example examples, learned WiFi password 602 may be provided to process 4-way handshake 600 and utilized to generate a PTK and MIC to verify the MIC provided by the WiFi device as discussed above.

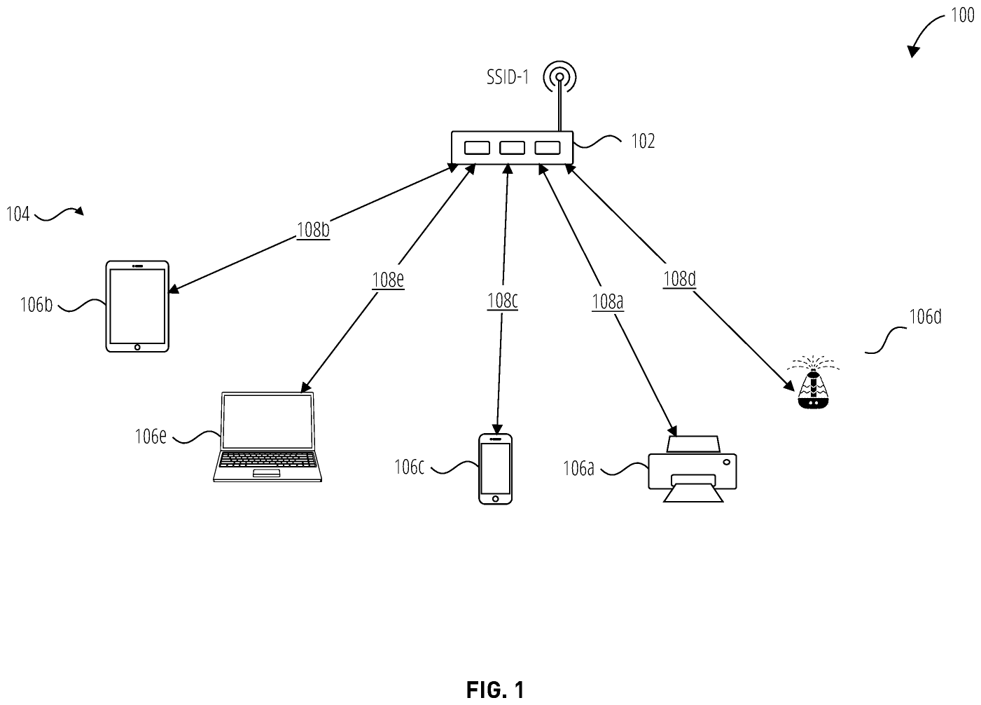

FIG. 1 is a block diagram depicting a WiFi network 100 in accordance with one or more examples. WiFi network 100 is managed by WiFi router 102, and is defined by a service set identifier, SSID-1. WiFi network 100 includes communication links 108a-108e between respective WiFi devices 104 (including WiFi Devices 106a-106e) and WiFi router 102 and a WiFi network designated as SSID-1. Each such communication link is individually secured (e.g., utilizing a protocol for establishing a secure communication link as discussed above, without limitation) with a different WiFi password, in accordance with one or more examples. By way of a non-limiting example, a first subset of secure communication links 108a-108e may be secured with a first WiFi password, and another, non-overlapping, subset of the secure communication links 108a-108e may be secured with a second WiFi password that is different than the first WiFi password. By way of a non-limiting example, secure communication links 108a-108e may respectively be secured with a unique WiFi password that is different from the WiFi passwords utilized to the secure the other ones of secure communication links 108a-108e.

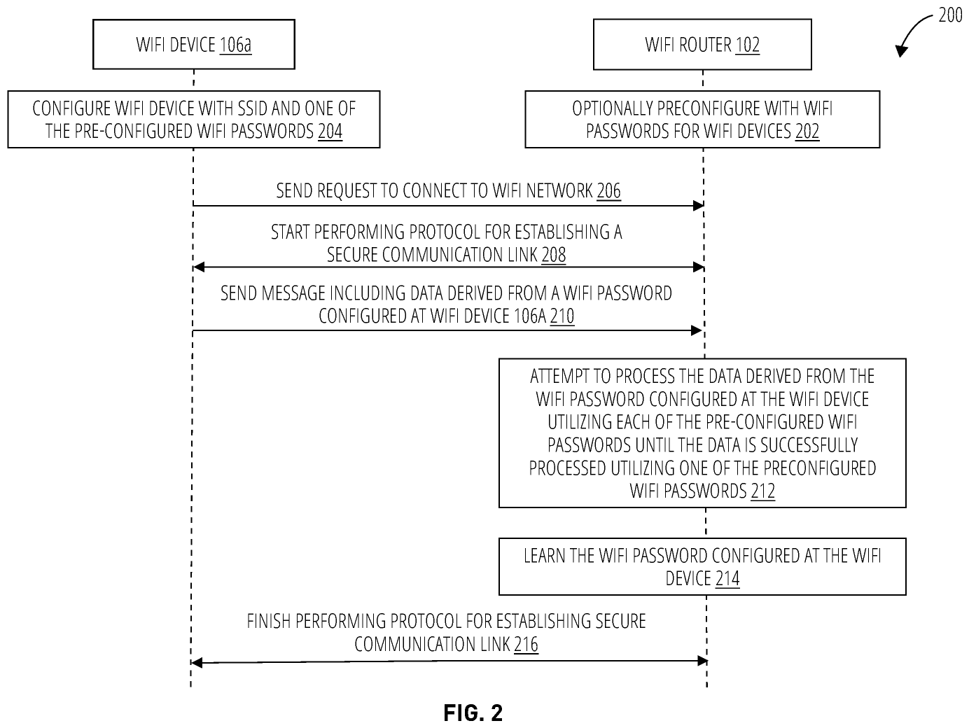

FIG. 2 is a diagram depicting a process 200 for establishing a secure communication link with a WiFi router, in accordance with one or more examples. In the specific non-limiting example depicted by FIG. 2, a printer, WiFi device 106a, attempts to connect to WiFi router 102, however, process 200 is a non-limiting example of a process for establishing any of establishing communication links 108a-108e of FIG. 1.

At operation 202 of process 200, WiFi router 102 is optionally preconfigured with a plurality of WiFi passwords (at least two) for establishing secure communication links with WiFi devices. Such WiFi passwords may be preconfigured at WiFi router 102 at assembly/manufacture of WiFi router 102, its computer (e.g., a microcontroller or microprocessor, without limitation), or by a user during setup of WiFi network 100, without limitation. The preconfigured WiFi passwords are stored at WiFi router 102. Operation 202 is optional, at least in part, because WiFi passwords may be configured at WiFi router 102 before WiFi device 106a attempts to connect or before WiFi router 102 is deployed.

At operation 204 of process 200, WiFi device 106a is configured with an SSID (here, SSID-1) of WiFi router 102 and with one of the WiFi passwords preconfigured at WiFi router 102 for that SSID. In various examples, WiFi device 106a may be a device that includes a physical user interface that may be utilized to input the SSID and the WiFi password for WiFi router 102, or may be a headless device that is provisioned with an SSID and WiFi password utilizing a provisioning device that has a physical user interface.

In one or more examples, WiFi router 102 may be configured to provide a user a list of available preconfigured WiFi passwords or a recommendation for one of the preconfigured WiFi passwords, for example, at a user interface of WiFi router 102 or via a device connected to WiFi router 102 such as smart phone, tablet computer, or desk or laptop computer, without limitation. In one or more examples, a variety of selection criteria may be utilized to select a WiFi password for WiFi device 106a, including without limitation: number of WiFi devices already associated with a given WiFi password, a class of device to which WiFi device 106a belongs (e.g., smart appliance, security system (e.g., locks, doorbells, cameras, without limitation), smart display, streaming device, smart thermostats or smoke detector, smart humidifiers, smart speaker, a personal computer or computer tablet, or a smart phone, without limitation), or a class of user associated with the device (e.g., minor, student, adult, resident, guest, or contractor, without limitation).

In one or more examples, WiFi router 102 may be configured to generate WiFi passwords, for example, automatically or in response to a user request, without limitation. As non-limiting examples, WiFi router 102 may be configured to generate a WiFi password because it detects that existing WiFi passwords are expired or have been associated with a threshold number of WiFi devices; because a user requests a new password; because a new class of device or user is created for the WiFi network; or because an SSID is changed or enabled at WiFi router 102. Generated WiFi passwords may increase the number of WiFi passwords at WiFi router 102 or replace expired WiFi passwords at WiFi router 102.

At operation 206 of process 200, WiFi device 106a sends a request to connect to the WiFi network 100 to WiFi router 102. While not depicted by FIG. 2, in one or more examples, WiFi router 102 and WiFi device 106a may exchange messages related to processing a connection request, such as messages for a ready notice, description of communication capabilities of WiFi device 106a, assigned identifier for WiFi device 106a, and approval from WiFi router 102 to continue the connection process.

At operation 208 of process 200, WiFi router 102 and WiFi device 106a start performing a protocol for establishing a secure communication link, such as a key agreement protocol (such as a 4-way handshake, without limitation) or a challenge-response protocol, as discussed above.

At operation 210 of process 200, WiFi device 106a sends a message, including data derived from the WiFi password with which WiFi device 106a was configured (see operation 204), to WiFi router 102, as non-limiting examples, a MIC of a 4-way handshake generated using the WiFi password as described above, data encrypted utilizing the WiFi password such an encrypted response-text, or an encryption key derived from the WiFi password.

At operation 212 of process 200, WiFi router 102 attempts to process the data derived from the WiFi password configured at WiFi device 106a utilizing each of the preconfigured WiFi passwords until the data is successfully processed utilizing one of the preconfigured WiFi passwords. In the specific non-limiting example depicted by FIG. 2, WiFi router 102 successfully processes the data utilizing one of the preconfigured WiFi passwords. Failure to successfully process the data utilizing any of the preconfigured WiFi passwords is specifically contemplated.

In one or more examples, specific processing operations performed by WiFi router 102 during operation 212 may correspond to the protocol for establishing a secure communication link being performed by the parties. In a case of a 4-way handshake, the processing operations performed by WiFi router 102 may include generating MICs utilizing PMKs derived from each of the preconfigured WiFi passwords and comparing the generated MICs to a MIC included in the data sent by WiFi device 106a at operation 210. In a case of a challenge-response protocol, processing operations performed by WiFi router 102 may include decrypting a cyphertext utilizing each of the preconfigured WiFi passwords and comparing the recovered plaintext to challenge text sent to WiFi device 106a.

At operation 214 of process 200, WiFi router 102 learns the WiFi password configured at the WiFi device 106a at least partially in response to successfully processing the data sent by WiFi device 106a utilizing one of the preconfigured WiFi passwords.

At operation 216 of process 200, WiFi device 106a and WiFi router 102 finish establishing a secure communication link by performing remaining operations of the protocol for establishing the secure communication link including, as a non-limiting example, exchanging the remaining messages of a 4-way handshake or a challenge-response protocol.

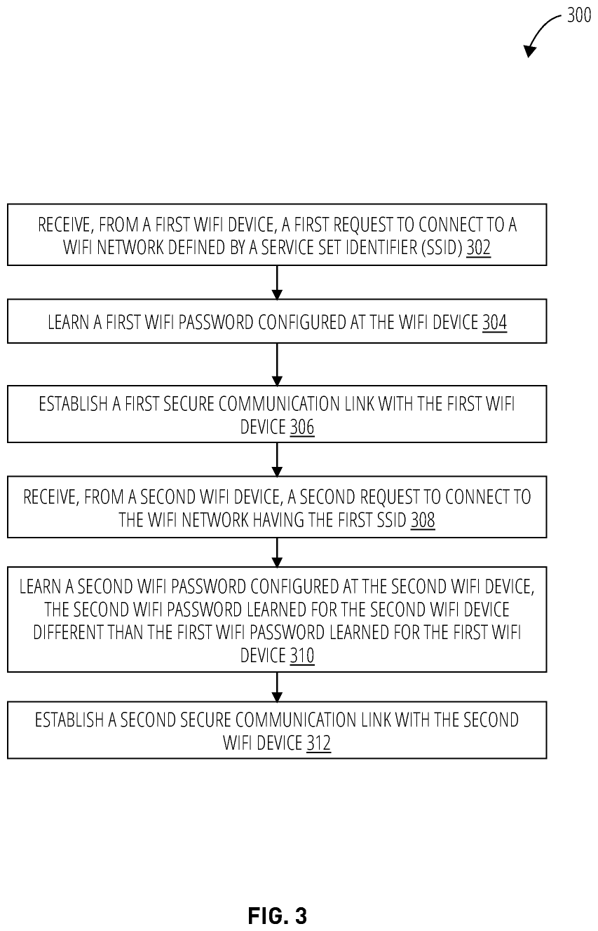

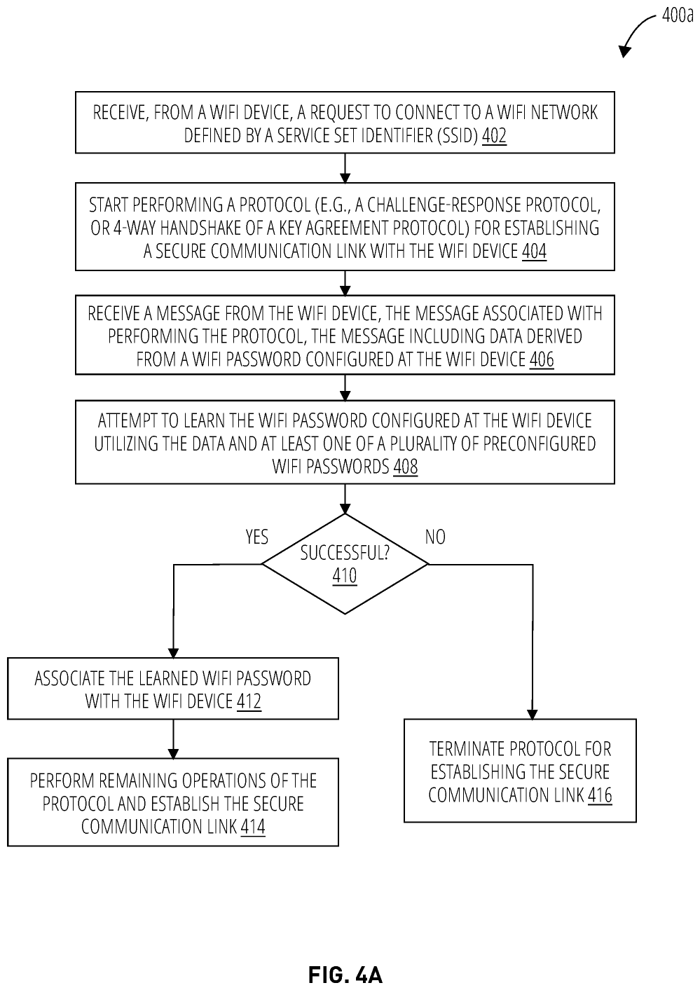

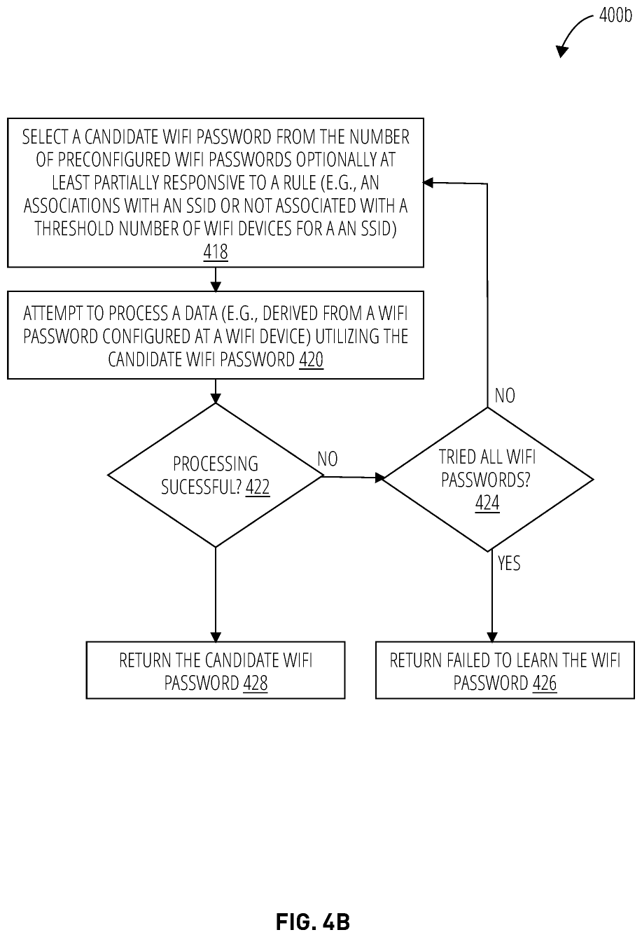

FIG. 3, FIG. 4A, and FIG. 4B are flow diagrams depicting various example processes performed by a disclosed WiFi router. FIG. 3 is flow diagram depicting a process 300 for utilizing different WiFi passwords to establish secure communication links with two WiFi devices. FIG. 4A is a flow diagram depicting a process 400a for establishing a secure communication link with a WiFi device when WiFi devices attempt to connect to a WiFi network utilizing different WiFi passwords, in accordance with one or more examples, such as process 300 depicted by FIG. 3, without limitation. FIG. 4B is a flow diagram depicting a process 400b for attempting to learn a WiFi password configured at a WiFi device attempting to establish a secure communication link with a WiFi router.

Turning to process 300 depicted by FIG. 3, at operation 302, process 300 receives, from a first WiFi device, a first request to connect to a WiFi network. The WiFi network may be defined by a service set identifier (SSID). At operation 304, process 300 learns a first WiFi password configured at the WiFi device. At operation 306, process 300 establishes a first secure communication link with the first WiFi device responsive to the learned first WiFi password. At operation 308, process 300 receives, from a second WiFi device, a second request to connect to the WiFi network defined by the single SSID. At operation 310, process 300 learns a second WiFi password configured at the second WiFi device, the second WiFi password learned for the second WiFi device different that the first WiFi password learned for the first WiFi device. At operation 312, process 300 establishes a second secure communication link with the second WiFi device responsive to the learned second WiFi password.

FIG. 4A is a flow diagram depicting a process 400a performed at a disclosed WiFi router, as a non-limiting example, as part of process 200, in accordance with one or more examples.

At operation 402, process 400a receives a request to connect to a WiFi network from a WiFi device, the WiFi network defined by a single SSID.

At operation 404, process 400a starts performing a protocol for establishing a secure communication link with the WiFi device, such as a 4-way handshake of a key agreement protocol or challenge-response protocol, without limitation.

At operation 406, process 400a receives a message from the WiFi device that is associated with the protocol. The message may include data derived from a WiFi password configured at the WiFi device. In one or more examples, the message may be a Msg2 of a 4-way handshake, discussed above, and the data may include a MIC. In one or more examples, the message may be a response message of a challenge-response protocol, discussed above, and the data may include cyphertext that is encrypted challenge text.

At operation 408, process 400a attempts to learn the WiFi password configured at the WiFi device utilizing the data and at least one of a plurality of preconfigured WiFi passwords, e.g., optionally preconfigured at the WiFi router In one or more examples, the WiFi router may have any number of preconfigured WiFi passwords that may be desirable. In one or more examples, the plurality of preconfigured WiFi passwords stored at the WiFi router may be configurable both before and while a WiFi router is deployed. In one or more examples, the content or values of the preconfigured WiFi passwords at the WiFi router may be changed both before and while a WiFi router is deployed.

At operation 410, process 400a determines if the attempt to learn the WiFi password configured at the WiFi device was successful. If the attempt was unsuccessful, then at operation 416 process 400a terminates the protocol for establishing the secure communication link and optionally for connecting to the WiFi network. If the attempt was successful, at operation 412, process 400a associates the learned WiFi password with the WiFi device and, at operation 414, process 400a performs the remaining operations of the protocol for establishing the secure communication link. In one or more examples, successfully learning the WiFi password configured at the WiFi device may serve to verify the data sent by the WiFi device. In one or more examples, the learned WiFi password may be passed to an instance of a process performing the protocol for establishing the secure communication link to utilize to verify the data sent by the WiFi device.

FIG. 4B is a flow diagram depicting a process 400b for attempting to learn a WiFi password configured at a WiFi device attempting to establish a secure communication link with a WiFi router, in accordance with one or more examples.

At operation 418, process 400b selects a candidate WiFi password from the plurality of preconfigured WiFi passwords. In one or more examples, process 400a may select this and other candidates at least partially based on an SSID utilized by the WiFi device to send the connection request.

Notably it is specifically contemplated that, in one or more examples, a WiFi password configured at a WiFi device attempting to connect to a WiFi network may be preconfigured at a WiFi router, yet not be among the available preconfigured WiFi passwords utilized by process 400b or a WiFi router more generally to select candidate WiFi passwords. In one or more examples, selection of a candidate WiFi password from the plurality of preconfigured WiFi passwords is optionally at least partially responsive to a rule, such as associated with a specific SSID or not associated with a threshold number of WiFi devices (e.g., an upper limit on the number of WiFi devices that may be associated with a specific preconfigured WiFi password, without limitation), without limitation.

As a non-limiting example, the WiFi password configured at the WiFi device may be one of the preconfigured WiFi passwords already associated with a threshold number of WiFi devices, and those preconfigured WiFi passwords are not available to a specific instance of process 400b. By way of another non-limiting example, only those preconfigured WiFi passwords associated with the SSID present in the connection request received at operation 402 may be available as candidate WiFi passwords, and the WiFi router may associate the WiFi password configured at the WiFi device with a different SSID.

At operation 420, process 400b attempts to process a data derived from a WiFi password configured at a WiFi device utilizing the candidate WiFi password, such as data included with a message from a WiFi device that is associated with performing a protocol for establishing a secure communication link with a WiFi device, without limitation.

At operation 422, process 400b determines whether the processing in operation 420 was successful. In one or more examples, the determination may include comparing a MIC generated using the candidate WiFi password at operation 418 matches a MIC sent by the WiFi device, or determining whether a decrypted response text matches challenge text sent to the WiFi device by the WiFi router.

If, at operation 422, process 400b determines that it unsuccessfully processed the data utilizing the candidate WiFi password, then at operation 424 process 400b determines if all available preconfigured WiFi passwords have been tried, i.e., determines if process 400b has attempted to process the data using all of the available preconfigured WiFi passwords. If not, then process 400b loops back to operation 418 and selects another candidate WiFi password. If attempts to process the data have been made using all of the available preconfigured WiFi passwords, then at operation 426 process 400b returns (e.g., to operation 408 of process 400a, without limitation) that process 400b failed to learn the WiFi password configured at the WiFi device.

If process 400b determines that processing was successful at operation 422, then at operation 428 process 400b returns (e.g., to operation 408 of process 400a, without limitation) the candidate WiFi password as the learned WiFi password.

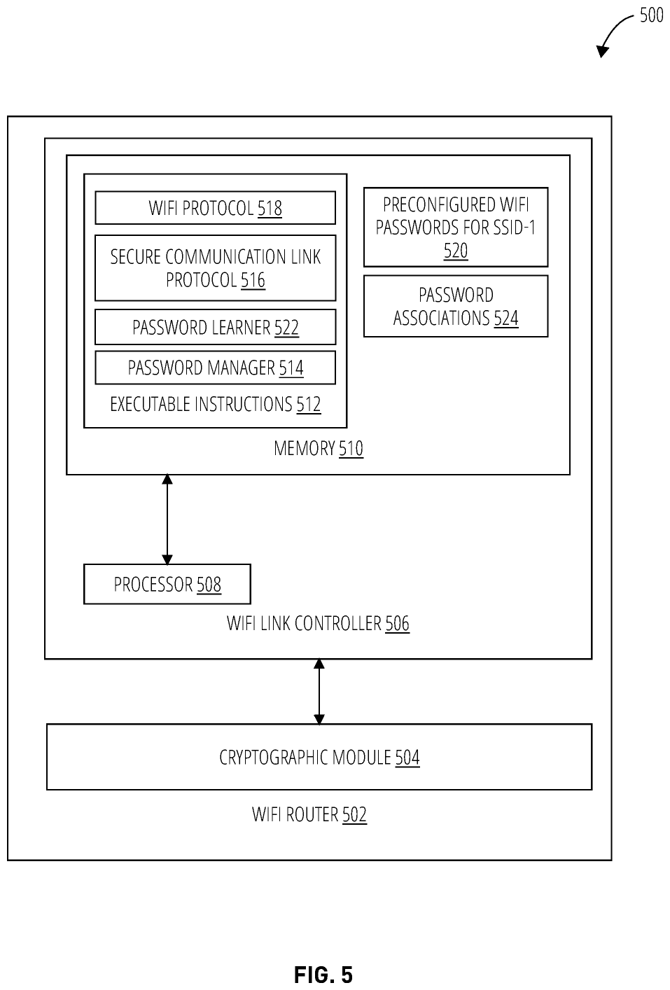

FIG. 5 is a block diagram depicting an apparatus 500 including a WiFi router 502 in accordance with one or more examples. In the specific non-limiting example depicted by FIG. 5, WiFi router 502 is configured, generally, to secure communication links with WiFi devices of a WiFi network utilizing different ones of Preconfigured WiFi passwords for SSID-1 520. In one or more examples, WiFi router 502 may include a WiFi link controller 506 and a cryptographic module 504.

In one or more examples, WiFi link controller 506 is configured, generally, to perform processes related to WiFi communication, including connection processes and establishing secure communication links as discussed herein. WiFi link controller 506 may include a processor 508 and a memory 510. The memory 510 may have stored thereon executable instructions 512, preconfigured WiFi passwords for SSID-1 520 and password associations 524.

Executable instructions 512 stored on memory 510 include executable instructions for a WiFi protocol 518, a secure communication link protocol 516, a password manager 514, and a password learner 522. Executable instructions of password manager 514, when executed by processor 508, are configured to enable processor 508 to perform some or a totality of operations for features and functions of managing preconfigured WiFi passwords at WiFi router 102 discussed herein, including in connection with process 200, process 400a and process 400b. For example, some or a totality of the operations associated with one or more of: associating learned WiFi passwords with specific WiFi devices and storing information describing the associations at password associations 524, generating WiFi passwords, saving new WiFi passwords at preconfigured WiFi passwords for SSID-1 520, replacing or deleting old WiFi passwords at preconfigured WiFi passwords for SSID-1 520, and selecting candidate WiFi passwords from the preconfigured WiFi passwords for SSID-1 520 for processing data.

Executable instructions of WiFi protocol 518, when executed by processor 508, are configured to enable processor 508 to perform some or a totality of operations for features and functions associated with the WiFi protocol.

Executable instructions of secure communication link protocol 516, when executed by processor 508, are configured to enable processor 508 to perform some or a totality of operations for features and functions of protocols for establishing a secure communication link discussed herein such as some or a totality of operations for performing: a 4-way handshake type of key agreement protocol or challenge-response protocol, without limitation.

Executable instructions of password learner 522, when executed by processor 508, are configured to enable processor 508 to perform some or a totality of operations for features and functions of learning a password configured at a WiFi device attempting to connect to WiFi router 502, including in connection with process 200, process 400a and process 400b.

Cryptographic module 504 is configured, generally, to perform cryptographic operations associated with secure communication link protocol 516 or WiFi protocol 518.

A person having ordinary skill in the art will appreciate that this disclosure is not limited to the specific non-limiting example partitioning of executable instructions depicted by FIG. 5. As non-limiting examples, executable instructions of password learner 522 may be incorporated with secure communication link protocol 516 or password manager 514; and executable instructions of secure communication link protocol 516 may be incorporated with WiFi protocol 518, and by virtue of that executable instructions of password learner 522 or password manager 514 incorporated with secure communication link protocol 516, if any, may incorporated with WiFi protocol 518.

As utilized in the present disclosure, the terms “module,” or “component” may refer to specific hardware implementations configured to perform the actions of the module or component or software objects or software routines that may be stored on or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and processes described in the present disclosure are generally described as being implemented in software (stored on or executed by general purpose hardware), specific hardware implementations or a combination of software and specific hardware implementations are also possible and contemplated.

As utilized in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms utilized in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” without limitation). As utilized herein, “each” means some or a totality. As utilized herein, “each and every” means a totality.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” or “an” should be interpreted to mean “at least one” or “one or more”); the same holds true for the use of definite articles utilized to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, without limitation” or “one or more of A, B, and C, without limitation” is utilized, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting embodiments of the disclosure include:

Example 1: a method, comprising: receiving, from a first WiFi device, a request to connect to a WiFi network defined by a service set identifier (SSID); receiving, from the first WiFi device, a first message associated with performing a protocol for establishing a secure communication link with the first WiFi device, the first message including data derived from a first WiFi password configured at the first WiFi device; and attempting to learn the first WiFi password configured at the first WiFi device utilizing the data and at least one of a plurality of preconfigured WiFi passwords.

Example 2: the method according to Example 1, comprising: associating a learned WiFi password with the first WiFi device at least partially responsive to successfully learning the first WiFi password configured at the first WiFi device; and performing remaining operations of the protocol to establish the secure communication link.

Example 3: the method according to any of Examples 1 and 2, comprising: terminate performing the protocol at least partially responsive to failing to learn the first WiFi password configured at the first WiFi device.

Example 4: the method according to any of Examples 1 through 3, wherein the plurality of preconfigured WiFi passwords are associated with the SSID defining the WiFi network.

Example 5: the method according to any of Examples 1 through 4, wherein the attempting to learn the first WiFi password configured at the first WiFi device utilizing the data and at least one of the plurality of preconfigured WiFi passwords comprises: selecting a candidate WiFi password from the plurality of preconfigured WiFi passwords; and attempting to process the data utilizing the candidate WiFi password.

Example 6: the method according to any of Examples 1 through 5, comprising: learning the candidate WiFi password as the first WiFi password configured at the first WiFi device at least partially responsive to successfully processing the data utilizing the candidate WiFi password.

Example 7: the method according to any of Examples 1 through 6, comprising: failing to learn the first WiFi password configured at the first WiFi device at least partially responsive to unsuccessfully processing the data utilizing the candidate WiFi password.

Example 8: the method according to any of Examples 1 through 7, wherein the performing the protocol for establishing the secure communication link comprises performing a 4-way handshake of a key agreement protocol.

Example 9: the method according to any of Examples 1 through 8, comprising: receiving, from a second WiFi device, a second request to connect to the WiFi network; receiving, from the second WiFi device, a second message associated with performing the protocol for establishing a secure communication link with the second WiFi device, the second message including second data derived from a second WiFi password configured at the second WiFi device; and attempting to learn the second WiFi password configured at the second WiFi device utilizing the second data and at least one of the plurality of preconfigured WiFi passwords.

Example 10: the method according to any of Examples 1 through 9, wherein the attempting to learn the second WiFi password configured at the second WiFi device utilizing the second data and the at least one of the plurality of preconfigured WiFi passwords comprises: selecting a candidate WiFi password from the plurality of preconfigured WiFi passwords; attempting to process the second data utilizing the candidate WiFi password; and learning the candidate WiFi password as the second WiFi password configured at the second WiFi device at least partially responsive to successfully processing the data utilizing the candidate WiFi password.

Example 11: the method according to any of Examples 1 through 10, wherein the first WiFi password is different than the second WiFi password.

Example 12: a system, comprising: a WiFi router, wherein the WiFi router is configured to: establish a first communication link with a first WiFi device, the first communication link secured utilizing a first WiFi password; and establish a second communication link with a second WiFi device, the second communication link secured utilizing a second WiFi password, wherein the first WiFi password is different than the second WiFi password.

Example 13: the system according to Example 12, wherein a WiFi network managed by the WiFi router is defined by a service set identifier and the first and second established communication links are with the WiFi network.

Example 14: the system according to any of Examples 12 and 13, further comprising the first WiFi device and the second WiFi device.

Example 15: an apparatus comprising: a processor; and a memory storing instructions that, when executed by the processor, configure the apparatus to: receive, from a first WiFi device, a request to connect to a WiFi network defined by a service set identifier (SSID); receive, from the first WiFi device, a first message associated with performing a protocol for establishing a secure communication link with the first WiFi device, the first message including data derived from a first WiFi password configured at the first WiFi device; and attempt to learn the first WiFi password configured at the first WiFi device utilizing the data and at least one of a plurality of preconfigured WiFi passwords.

Example 16: the apparatus according to Example 15, wherein the instructions, when executed by the processor, configure the apparatus to: associate a learned WiFi password with the first WiFi device responsive to successfully learning the first WiFi password configured at the first WiFi device; and perform remaining operations of the protocol for establishing the secure communication link with the first WiFi device.

Example 17: the apparatus according to any of Examples 15 and 16, wherein the instructions, when executed by the processor, configure the apparatus to: terminate the performing the protocol at least partially responsive to failing to learn the first WiFi password configured at the first WiFi device.

Example 18: the apparatus according to any of Examples 15 through 17, wherein the attempt to learn the first WiFi password configured at the first WiFi device utilizing the data and the at least one of the plurality of preconfigured WiFi passwords comprises: select a candidate WiFi password from the plurality of preconfigured WiFi passwords; and attempt to process the data utilizing the candidate WiFi password.

Example 19: the apparatus according to any of Examples 15 through 18, wherein the instructions, when executed by the processor, configure the apparatus to: learn the candidate WiFi password as the first WiFi password configured at the first WiFi device at least partially responsive to successfully processing the data utilizing the candidate WiFi password.

Example 20: the apparatus according to any of Examples 15 through 19, wherein the instructions, when executed by the processor, configure the apparatus to: fail to learn the first WiFi password configured at the first WiFi device at least partially responsive to unsuccessfully processing the data utilizing the candidate WiFi password.

Example 21: the apparatus according to any of Examples 15 through 20, wherein the protocol for establishing the secure communication link comprises a 4-way handshake of a key agreement protocol.

Example 22: the apparatus according to any of Examples 15 through 21, wherein the instructions, when executed by the processor, configure the apparatus to: receive, from a second WiFi device, a second request to connect to the WiFi network; receive, from the second WiFi device, a second message associated with the protocol for establishing a secure communication link with the second WiFi device, the second message including second data derived from a second WiFi password configured at the second WiFi device; and attempt to learn the second WiFi password configured at the second WiFi device utilizing the second data and the at least one of the plurality of preconfigured WiFi passwords.

Example 23: the apparatus according to any of Examples 15 through 22, wherein the attempt to learn the second WiFi password configured at the second WiFi device utilizing the second data and the at least one of the plurality of preconfigured WiFi passwords comprises: select a candidate WiFi password from the plurality of preconfigured WiFi passwords; attempt to process the second data utilizing the candidate WiFi password; and learn the candidate WiFi password as the second WiFi password configured at the second WiFi device at least partially responsive to successfully processing the data utilizing the candidate WiFi password.

Example 24: the apparatus according to any of Examples 15 through 23, wherein a learned second WiFi password is different than a learned first WiFi password.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventor.

What is claimed is:

1. A method, comprising:
receiving, from a first WiFi device, a request to connect to a WiFi network defined by a service set identifier (SSID);
receiving, from the first WiFi device, a first message associated with performing a protocol for establishing a secure communication link with the first WiFi device, the first message including data derived from a first WiFi password configured at the first WiFi device; and
attempting to learn the first WiFi password configured at the first WiFi device utilizing the data and at least one of a plurality of preconfigured WiFi passwords.

2. The method of claim 1, comprising:
associating a learned WiFi password with the first WiFi device at least partially responsive to successfully learning the first WiFi password configured at the first WiFi device; and
performing remaining operations of the protocol to establish the secure communication link.

3. The method of claim 1, comprising:
terminate performing the protocol at least partially responsive to failing to learn the first WiFi password configured at the first WiFi device.

4. The method of claim 1, wherein the plurality of preconfigured WiFi passwords are associated with the SSID defining the WiFi network.

5. The method of claim 1, wherein the attempting to learn the first WiFi password configured at the first WiFi device utilizing the data and at least one of the plurality of preconfigured WiFi passwords comprises:
selecting a candidate WiFi password from the plurality of preconfigured WiFi passwords; and
attempting to process the data utilizing the candidate WiFi password.

6. The method of claim 5, comprising:
learning the candidate WiFi password as the first WiFi password configured at the first WiFi device at least partially responsive to successfully processing the data utilizing the candidate WiFi password.

7. The method of claim 5, comprising:
failing to learn the first WiFi password configured at the first WiFi device at least partially responsive to unsuccessfully processing the data utilizing the candidate WiFi password.

8. The method of claim 1, wherein the performing the protocol for establishing the secure communication link comprises performing a 4-way handshake of a key agreement protocol.

9. The method of claim 1, comprising:
receiving, from a second WiFi device, a second request to connect to the WiFi network;
receiving, from the second WiFi device, a second message associated with performing the protocol for establishing a secure communication link with the second WiFi device, the second message including second data derived from a second WiFi password configured at the second WiFi device; and
attempting to learn the second WiFi password configured at the second WiFi device utilizing the second data and at least one of the plurality of preconfigured WiFi passwords.

10. The method of claim 9, wherein the attempting to learn the second WiFi password configured at the second WiFi device utilizing the second data and the at least one of the plurality of preconfigured WiFi passwords comprises:
selecting a candidate WiFi password from the plurality of preconfigured WiFi passwords;
attempting to process the second data utilizing the candidate WiFi password; and
learning the candidate WiFi password as the second WiFi password configured at the second WiFi device at least partially responsive to successfully processing the data utilizing the candidate WiFi password.

11. The method of claim 9, wherein the first WiFi password is different than the second WiFi password.

12. A system, comprising:
a WiFi router, wherein the WiFi router is configured to:
establish a first communication link with a first WiFi device, the first communication link secured utilizing a first WiFi password; and
establish a second communication link with a second WiFi device, the second communication link secured utilizing a second WiFi password, wherein the first WiFi password is different than the second WiFi password.

13. The system of claim 12, wherein a WiFi network managed by the WiFi router is defined by a service set identifier and the first and second established communication links are with the WiFi network.

14. The system of claim 12, further comprising the first WiFi device and the second WiFi device.

15. An apparatus comprising:
a processor; and
a memory storing instructions that, when executed by the processor, configure the apparatus to:
receive, from a first WiFi device, a request to connect to a WiFi network defined by a service set identifier (SSID);
receive, from the first WiFi device, a first message associated with performing a protocol for establishing a secure communication link with the first WiFi device, the first message including data derived from a first WiFi password configured at the first WiFi device; and
attempt to learn the first WiFi password configured at the first WiFi device utilizing the data and at least one of a plurality of preconfigured WiFi passwords.

16. The apparatus of claim 15, wherein the instructions, when executed by the processor, configure the apparatus to:
associate a learned WiFi password with the first WiFi device responsive to successfully learning the first WiFi password configured at the first WiFi device; and
perform remaining operations of the protocol for establishing the secure communication link with the first WiFi device.

17. The apparatus of claim 15, wherein the instructions, when executed by the processor, configure the apparatus to:
terminate the performing the protocol at least partially responsive to failing to learn the first WiFi password configured at the first WiFi device.

18. The apparatus of claim 15, wherein the attempt to learn the first WiFi password configured at the first WiFi device utilizing the data and the at least one of the plurality of preconfigured WiFi passwords comprises:
select a candidate WiFi password from the plurality of preconfigured WiFi passwords; and
attempt to process the data utilizing the candidate WiFi password.

19. The apparatus of claim 18, wherein the instructions, when executed by the processor, configure the apparatus to:
learn the candidate WiFi password as the first WiFi password configured at the first WiFi device at least partially responsive to successfully processing the data utilizing the candidate WiFi password.

20. The apparatus of claim 18, wherein the instructions, when executed by the processor, configure the apparatus to:
fail to learn the first WiFi password configured at the first WiFi device at least partially responsive to unsuccessfully processing the data utilizing the candidate WiFi password.

21. The apparatus of claim 15, wherein the protocol for establishing the secure communication link comprises a 4-way handshake of a key agreement protocol.

22. The apparatus of claim 15, wherein the instructions, when executed by the processor, configure the apparatus to:
receive, from a second WiFi device, a second request to connect to the WiFi network;
receive, from the second WiFi device, a second message associated with the protocol for establishing a secure communication link with the second WiFi device, the second message including second data derived from a second WiFi password configured at the second WiFi device; and
attempt to learn the second WiFi password configured at the second WiFi device utilizing the second data and the at least one of the plurality of preconfigured WiFi passwords.

23. The apparatus of claim 22, wherein the attempt to learn the second WiFi password configured at the second WiFi device utilizing the second data and the at least one of the plurality of preconfigured WiFi passwords comprises:
select a candidate WiFi password from the plurality of preconfigured WiFi passwords;
attempt to process the second data utilizing the candidate WiFi password; and
learn the candidate WiFi password as the second WiFi password configured at the second WiFi device at least partially responsive to successfully processing the data utilizing the candidate WiFi password.

24. The apparatus of claim 23, wherein a learned second WiFi password is different than a learned first WiFi password.
